(19) United States
(12) Patent Application Publication
(10) Pub. No.: US 2007/0229856 A1
(43) Pub. Date: Oct. 4, 2007

(54) Printer apparatus, printing method, and printer system

(75) Inventor: Junko Komine, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/485,418

(22) Filed: Jul. 13, 2006

(30) Foreign Application Priority Data
Mar. 29, 2006 (JP) 2006-089957

(51) Int. Cl. G06F 3/12

(52) U.S. Cl. 358/1.1

(57) ABSTRACT

To make it possible to print the document data having been revised a multiple number of times with emphasis (different property) added only on parts which have been revised at a specific revision, so that an operator can easily recognize the parts having been changed at the specific revision, the printer apparatus includes a version number specifying unit which specifies the revision version number information of the document data, which revision version number information is generated when a document is revised by changing the contents thereof; and a printing unit which performs, on the basis of the revision version number information specified by said version number specifying unit, a printing operation of a revised part of the document corresponding to the revision version number information with a property different from that of the other parts of the document.

### BACKGROUND OF THE INVENTION

(1) Field of the Invention

The present invention relates to an art for printing document data which has been revised by changing the contents thereof.

(2) Description of the Related Art

When document data is produced with a document producing application which is installed in a personal computer, for example, letters (including characters and numerics) can be changed, the document data being thereby revised. At the time of revising the document data, the changed letters are made to have a property different from that of the other parts of the document so that the changed parts (for example, collected, added, or deleted) are distinguishable from the other parts on the screen of the display or a hard copy (see, for example, the following patent documents 1 through 4).

In this instance, the updating of revision (the number of times of revision) can be arbitrarily set by an operator who produces (changes) document data, or it can be performed when a processing terminal or an operator that produces the document data is changed.

The property of the parts changed at the time of revision is altered by changing the color of letters that are amendments, by underlining the letters, by shading the letters, or by changing the font, the thickness, or the size of the letters. This makes it possible to distinguish the property of the changed letters from that of the other letters of the document. Further, when original letters are deleted, such letters to be deleted are sometimes not erased, but a strike-through is put on the letters to be deleted. In such a manner, the deleted letters can be left to show change tracking.

It is to be noted that, in the following description, the property of letters means the color, the font, the size, the thickness of letters, the presence or absence of an underline, the type of underline, the presence or absence of shading on letters, the type of shading, the presence or absence of a strike-through, and the type of strike-through.

Here, a different property is given to the changed parts every time the document data is revised. If the revision is performed a multiple number of times, the document data contains letters with varying types of properties, so that the document becomes visibly complicated and difficult to see. For example, when the color of changed parts is altered, if revision is performed a multiple number of times, the document data contains letters of a variety of colors, so that the document is difficult to read. As a result, it becomes difficult to distinguish when (that is, how-manieth revision), where, and in what way the changes were performed.

According to the previous art disclosed in the following patent document 1 through 4, assuming that revision is performed a multiple number of times for producing document data, when the document data is printed, it is impossible to print the document data with emphasis only on parts which have been changed during one specific revision out of multiple revisions that have been performed.

That is, for example, when document data in which the color of changed parts has been altered, it is possible for an operator to select monochrome print or color print, but it is impossible to print the document with only those parts changed at a specific revision in color (that is, it is impossible to select the color of parts to be printed in color).

[Patent Document 1] Japanese Patent Application Laid-open No. HEI 4-195459

[Patent Document 2] Japanese Patent Application Laid-open No. HEI 9-101957

[Patent Document 3] Japanese Patent Application Laid-open No. HEI 8-161327

[Patent Document 4] Japanese Patent Application Laid-open No. HEI 9-147027

### SUMMARY OF THE INVENTION

With the foregoing problems in view, it is an object of the present invention to make it possible to print the document data with emphasis on a special property of only parts that have been changed at a specific revision, so that an operator can easily recognize parts that have been changed at the specific revision.

In order to accomplish the above object, according to the present invention, there is provided a printer apparatus which prints document data including revision version number information that is generated when a document is revised by changing the contents thereof, the printer apparatus comprising: a version number specifying unit which specifies the revision version number information of the document data; and a printing unit which performs, on the basis of the revision version number information specified by the version number specifying unit, a printing operation of a revised part of the document corresponding to the revision version number information with a property different from that of the other parts of the document.

As a preferred feature, the document data further includes special property information corresponding to the revision version number information, which special property information is obtained by changing the property of a part revised at the time of revision, and the printing unit performs the printing operation on the basis of the special property information corresponding to the revision version number information specified by the version number specifying unit.

As another preferred feature, the printing unit includes: an analyzing unit which analyzes, in order to print the document data, character letters contained in the document data on the basis of the revision version number information specified by the version number specifying unit; and a print-out unit which prints out an analysis result obtained by the analyzing unit.

As a generic feature, there is provided a printing method for printing document data including revision version number information that is generated when a document is revised by changing the contents thereof, the method comprising the steps of: (a) specifying the revision version number information of the document data; and (b) performing, on the basis of the revision version number information specified by the version number specifying unit, a printing operation of a revised part of the document corresponding to the revision version number information with a property different from that of the other parts of the document.

As another generic feature, there is provided a printer system, comprising: a processing apparatus which requests printing of document data which includes revision version number information that is generated when a document is revised by changing the contents thereof; and a printer apparatus which prints the document data in response to a request from the processing apparatus, the processing apparatus including a version number specifying unit which specifies the revision version number information of the document data; the printing apparatus including a printing unit which performs, on the basis of the revision version number information specified by the version number specifying unit, a printing operation of a revised part of the document corresponding to the revision version number information with a property different from that of the other parts of the document.

As described so far, according to the present invention, the version number specifying unit specifies revision version number information contained in the document data (version number specifying step), and the printing unit performs, on the basis of the revision version number information specified by the version number specifying unit, a printing operation of a revised part of the document corresponding to the revision version number information with a property different from that of the other parts of the document (printing step). Thus, even when revision of the document data is performed multiple number of times, when the document data is printed, the version number specifying unit specifies a specific one of the revision version information pieces, whereby the document is printed with emphasis only on the part changed at the specified version with a property different from that of the other parts of the document, so that it is possible for an operator to easily recognize the parts having been changed at a specific revision in the printed document.

Other objects and further features of the present invention will be apparent from the following detailed description when read in conjunction with the accompanying drawings.

### BRIEF DESCRIPTION OF THE DRAWINGS

FIG. 1 is a block diagram illustrating a construction of a printer system according to a first preferred embodiment of the present invention;

FIG. 2 is a diagram illustrating an example construction of document data produced by a document data producing unit of a processing apparatus of the printer system of the first embodiment;

FIG. 3 is a diagram illustrating an example of a screen image which is shown on a display by a version number specifying unit of the processing apparatus of the printer system of the first embodiment;

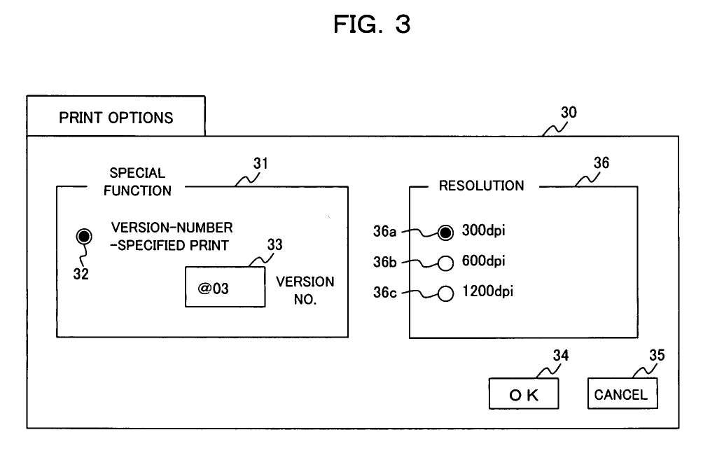

FIG. 4 is a diagram illustrating an example of a document printed by a printing unit of a printer apparatus of the printer system of the first embodiment;

FIG. 5 is a flowchart of operation procedures of a printing method according to the first embodiment;

FIG. 6 is a block diagram illustrating a construction of a printer system of a second embodiment of the present invention;

FIG. 7 is a perspective view of a printer apparatus of the printer system of the second embodiment;

FIG. 8 is a diagram for describing a version number setting screen image shown on a display by the version number specifying unit of the printer apparatus of the printer system of the second embodiment;

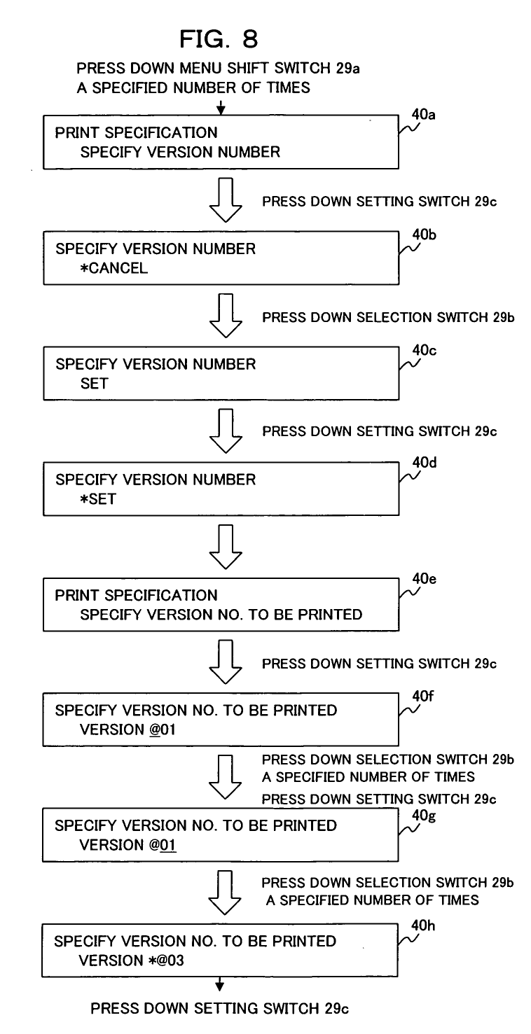

FIG. 9 is a block diagram illustrating a construction of a printer system as a modified example of the present invention;

FIG. 10 is a diagram illustrating a construction example of document data produced by a document data producing unit of the processing apparatus of the printer system as a modified example of the present invention;

FIG. 11 is a diagram illustrating an example of a document printed by the printing unit of the printer apparatus of the printer system as the modified example of the present invention; and

FIG. 12 is a block diagram illustrating a construction of a printer system as a modified example of the present invention.

### DESCRIPTION OF THE PREFERRED EMBODIMENT(S)

Embodiments of the present invention will now be described with reference to the relevant accompanying drawings.

### [1] First Embodiment

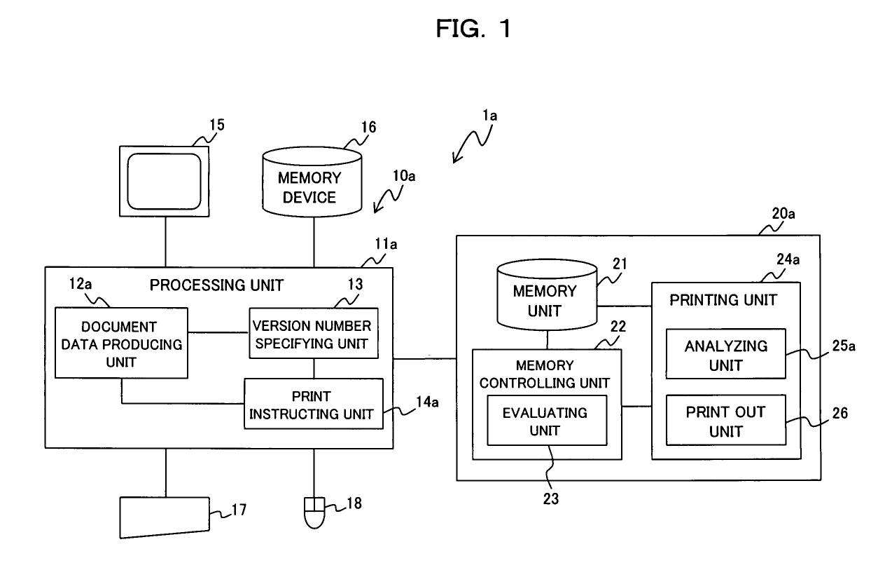

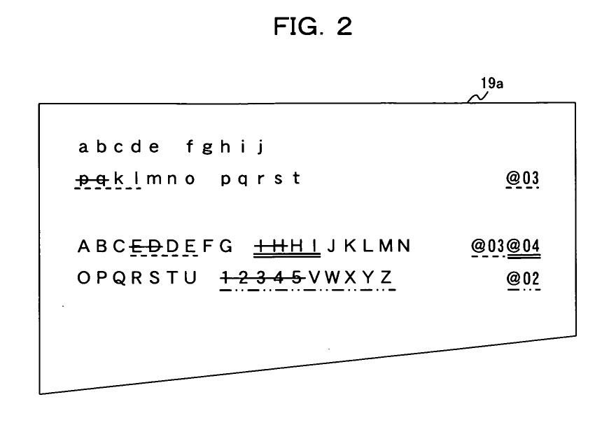

First of all, referring to the block diagram of FIG. 1, a description will be made of a construction of a printer system 1a according to a first embodiment of the present invention. As shown in FIG. 1, the printer system 1a, which produces document data [see, for example, FIG. 2 (detailed later)], includes: a processing apparatus 10a which requests printing of the produced document data; and a printer apparatus 20a which prints the document data in response to the print request from the processing apparatus 10a.

The processing apparatus 10a is given as, for example, a personal computer, and includes: a processing unit 11a; a display (monitor) 15; a memory device 16; a keyboard 17; and a mouse 18.

The processing unit 11a includes: a document data producing unit 12a; a version number specifying unit 13; and a print instructing unit 14a.

The document data producing unit 12a is a document producing tool which is realized by the CPU (Central Processing Unit; not illustrated) of the processing unit 11a by means of its executing a document producing application program stored in the memory device 16.

This document data producing unit 12a produces document data under instructions of an operator of the processing apparatus 10a, which instructions are input through input interfaces such as the keyboard 17 and the mouse 18. In this instance, the document data produced by the document data producing unit 12a is stored in the memory device 16.

Here, a description will be made of an example of document data produced by the document data producing unit 12a. As shown in FIG. 2, the document data 19a produced by the document data producing unit 12a includes revision version information (here, “@2”, “@3”, and “@4”) which is generated (here, recorded as character letters) when the contents of a document are changed and the version of the document are changed.

Further, in the document data 19a, to distinguish parts which have been changed when the document version is changed, the property of the letters of the changed part is altered so that the property differs from that of the letters of the other part of the document.

That is, in the parts which have been changed at the time of change of document version, letters with a special property, which differs from that of the letters in the other part of the document, are used. Further, revision version number information (@2, @3, and @4) which indicates the time of revision performed, is recorded in the document data 19a as letters with the same special property as that of the changed part.

Accordingly, the document data 19a contains not only the revision version number information but also special property information corresponding to the revision version number information, which special property information has been obtained by changing the property of the parts, changed at the time of change of the version, into a property different from that of the other part of the document.

More specifically, in the document data 19a, the parts changed at version 2 (version @02), version 3 (version @03), and version 4 (version @04), and revision version number information (@02, @03, and @04 each) are recorded as letters underlined by different types of underlines respectively.

In this instance, in the document data 19a, the strike-throughs on letters (“1” through “5”, “p”, “q”, “E”, “D”, “I”, and “H”) are directly recorded by an operator when the document is revised (that is, directly recorded by an operator through the keyboard 17 and the mouse 18). These strike-throughs are not included in the special property information in the document data 19a, and they are treated in the same way as normal character letter information. Hence, regardless of the presence or the absence of specification of the revision version number information by the version number specifying unit 13 (described later), all these strike-throughs are always printed by the printer apparatus 20a.

Then, at revision version 2, strike-throughs are put on letters “1” through “5”, and letters “V” through “Z” are newly recorded (added) by an operator. Such changed letters are underlined by an operator with a two-dotted line, and revision version information, “@02”, underlined by a two-dotted line is recorded by the operator at the end (the right end in the example) of the line which contains the changed part (“1” through “5” and “V” through “Z”).

Further, at revision version 3, strike-throughs are put on letters “p” “q”, “E”, and “D”, and letters “k”, “l”, “D”, and “E” are newly recorded (added). Such changed letters are underlined by an operator with broken lines, and revision version information, “@03”, underlined by a broken line is recorded by the operator at the ends (the right ends in this example) of the lines which contain the changed parts (“p”, “q”, “E”, and “D”, and “k”, “l”, “D”, and “E”).

Still further, at revision version 4, strike-throughs are put on letters “I” and “H”, and letters “H” and “I” are newly recorded (added). Such changed letters are underlined by an operator with a double line, and revision version information, “@04”, underlined by a double line is recorded by the operator at the end (the right end in this example) of the line which contains the changed parts (“I”, “H”, and “H”, “I”).

Here, a description will be made of revision version information “ [symbol] 02 through [symbol] 04” which is recorded by an operator. Each piece of revision version number information “ [symbol] 02”, “ [symbol] 03”, and “ [symbol] 04” is composed of a control character letter “ [symbol] and numerals “02”, “03”, and “04”.

In addition, each piece of revision version number information “ [symbol] 02”, “ [symbol] 03”, and “ [symbol] 04” contains the corresponding special property information (that is, underlined with the corresponding types of underlines) For example, when the document data 19a is shown on the screen of the display 15, it is possible for an operator to visually identify which parts were changed on which revision version.

Further, as shown in FIG. 1, when the document data 19a generated by the document data producing unit 12a is printed, the version number specifying unit 13 of the processing unit 11a specifies the revision version information “ [symbol] 02”, “ [symbol] 03”, or “ [symbol] 04”, so that only parts having been changed at the specified revision version are printed in an emphasized manner with its corresponding special property.

The version number specifying unit 13 cooperates with a display controlling unit (not illustrated) which controls the contents shown on the screen of the display 15, to make the display 15 show thereon a version number setting screen image 30 through which an operation inputs revision version number information. On the basis of instructions which are input by the operator through the version number setting screen image 30, the version number specifying unit 13 specifies the revision version number information.

The version number setting screen image 30 is a print option screen image which is shown after a printing operation of the document data 19a is set through, for example, a print setting screen image (not shown). The revision version number information set by the version number specifying unit 13 is adapted to be set as a special function at a printing operation of the document data 19a.

Here, a description will be made of a method for specifying the revision version number information carried out by an operator through the version number setting screen image 30. First of all, the operator uses the mouse 18 to move the pointer of the mouse 18 onto the button 32 on the left of the special function field labeled as “version-number-specified print”. After clicking the mouse button, thereby making the button 32 into a marked state, the operator uses the keyboard 17 to input the revision version information (here, “ [symbol] 03”) corresponding to the revision version which the operator hopes to emphasize at the time of printing.

Finally, the operator uses the mouse 18 to move the pointer thereof onto the OK button 34, and then clicks the mouse button of the mouse 18, thereby pressing down the OK button 34. In this manner, the revision version number information “ [symbol] 03” is set.

The resolution field 36 in the version number setting screen image 30 specifies the resolution with which the document data is to be printed. After one of the multiple buttons 36a through 36ccorresponding to the multiple resolutions (here, “300 dpi”, “600 dpi”, and “1200 dpi”) is respectively checked, the document data 19a is printed with the selected resolution.

The cancel button 35 is a button to be pressed down when the revision version number having been set or the resolution having been specified is cancelled.

The print instructing unit 14a requests the printer apparatus 20a to print the document data to which is added the revision version information specified by the version number specifying unit 13.

This print instructing unit 14a sends the document data 19a and the revision version information specified by the version number specifying unit 13 to the printer apparatus 20a as a print request with the timing with which the OK button 34 in the version number setting screen image 30 is pressed down.

In this instance, the version number specifying unit 13 and the print instructing unit 14a are realized by means of, for example, executing an application program as a printer driver of the printer apparatus 20a on the CPU of the processing unit 11a.

Next, a description will be made of the printer apparatus 20a. The printer apparatus 20a includes: a memory unit 21; a memory controlling unit 22; and a printing unit 24a.

The memory unit 21 stores data, and the memory controlling unit 22 controls storing data in the memory unit 21.

Upon receipt of a print request from the print instructing unit 14a of the processing apparatus 10a, the memory controlling unit 22 stores the document data 19a contained in the print request in the memory unit 21.

Further, the memory controlling unit 22 includes an evaluating unit 23 which evaluates whether or not the revision version number information specified by the version number specifying unit 13 is included in the print request from the print instructing unit 14a. If the evaluating unit 23 decides that the print request contains the revision version number information specified by the version number specifying unit 13, this revision version number information is stored in the memory unit 21 in association with the document data 19a.

On the other hand, if the evaluating unit 23 decides that the print request does not contain any revision version number information, the memory controlling unit 22 stores only the document data 19a contained in the print request.

The printing unit 24a, which includes the analyzing unit 25a and the print out unit 26, prints the document data 19a. At the time of printing, a printing unit 24a which performs, on the basis of the revision version number information specified by the version number specifying unit 13, a printing operation of a revised part of the document corresponding to the revision version number information with a property different from that of the other parts of the document.

In order to print the document data 19a stored in the memory unit 21, the analyzing unit 25a analyzes character letters contained in the document data 19a, thereby converting the letters of the document data 19a into data printable by the print out unit 26 (For example, data of fonts printable by the print out unit 26).

On the basis of the analysis (conversion) result obtained by the analyzing unit 25a, the print out unit 26 prints the document data 19a on paper sheets or the like.

Here, a description will be made of processing performed by the analyzing unit 25a when the version number specifying unit 13 of the processing apparatus 10a specifies revision version number information “@03” (that is, revision version number information “@03” is added to the print request from the print instructing unit 14a). In this case, since the memory unit 21 stores the revision version number information “@03” specified by the version number specifying unit 13 together with the document data 19a, the analyzing unit 25a analyzes and converts the character letter information contained in the document data 19a on the basis of the document data 19a and revision version number information “@03” held in the memory unit 21 so that the print out unit 26 is capable of printing out the character letter information.

More specifically, when analyzing the document data 19a, the analyzing unit 25a distinguishes between normal letters forming the text of the document data 19a and revision version information “ [symbol] 02 through [symbol] 04” based on the control character [symbol] in the revision version number information “ [symbol] 03”, and then further recognizes the revision version number information “ [symbol] 03”.

That is, the analyzing unit 25a keeps analyzing letters contained in the document data 19a, and when the character [symbol] is detected, the analyzing unit 25a recognizes the thus detected [symbol] and the numeric “03” following the character [symbol] as revision version number information “ [symbol] 03”.

Then, the analyzing unit 25a obtains special property information (here, a broken underline) corresponding to this revision version number information “@03” from the revision version number information “@03”. The analyzing unit 25a then recognizes letters to which such special property information is added in the document data 19a (here, “p”, “q”, “E”, “D”, and “k”, “l”, “D”, “E”) as the letters which were changed at the time of revision (revision version 3) which the revision version number information “@03” indicates, whereby the analyzing unit 25a judges that these letters should be underlined by broken lines, which is indicated by the special property information.

On the other hand, the analyzing unit 25a analyzes that the other parts to which no special property information is added should be printed with an original property which has never been changed from the initial version, with no consideration paid to special property information.

That is, the analyzing unit 25a converts the letters (“1” through “5” and “V” through “Z”) underlined with the two-dotted line, which letters are changed in revision version 2, indicated by the revision version information “@02” in the document data 19a, in such a manner that the letters are printed as original letters not underlined with the two-dotted line.

In addition, the analyzing unit 25a converts the letters (“I”, “H” and “H”, “I”) underlined with the double line, which letters are changed in revision version 4, indicated by the revision version information “@04” in the document data 19a, in such a manner that the letters are printed as original letters not underlined with the double line.

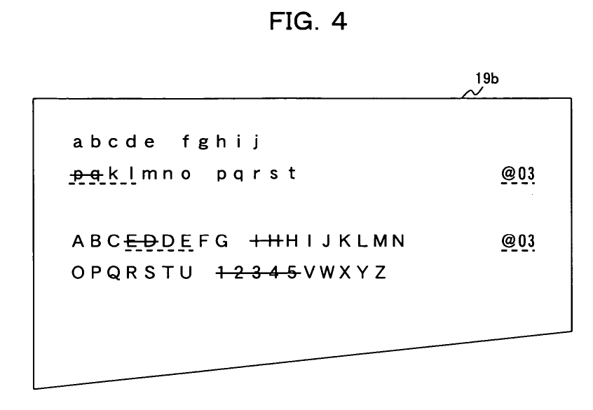

Accordingly, when the print out unit 26 prints an analysis result obtained by the analyzing unit 25a, a print out result as shown in FIG. 4 is obtained. In the document 19b of FIG. 4, only the parts (“p”, “q”, “E”, “D” and “k”, “l”, “D”, “E”) changed in revision version 3 corresponding to the revision version information “ [symbol] 03” specified by the version number specifying unit 13 are underlined with broken lines. That is, the parts changed in revision version 3 corresponding to revision version information “@03” specified by the version number specifying unit 13 of the processing apparatus 10a are printed with a property different from that of the other parts of the document.

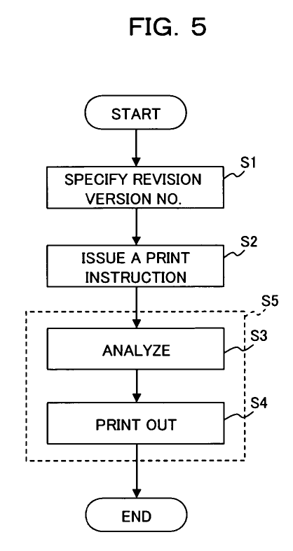

Next, referring to the flowchart (step S1 through S5) of FIG. 5, a description will be made of a printing method (operation procedures of the present printer system 1a) according to a first embodiment of the present invention. First of all, the version number specifying unit 13 specifies the revision version number information “@03” in the document data 19a containing the revision version number information “ [symbol] 02 through [symbol] 04” and special property information corresponding to the revision version information “02 through [symbol] 04”, which document data 19a was produced by the document data producing unit 12a of the processing apparatus 10a (step S1; version specifying step).

Next, the print instructing unit 14a issues a print instruction for printing the document data 19a to which is added the revision version number information “@03” specified by the version number specifying unit 13 at step S1 to the printer apparatus 20a (step S2; print instruction step).

When the printer apparatus 20a receives the print instruction from the print instructing unit 14a, the memory unit 21 stores therein the document data 19a and the revision version number information “@03” contained in the print instruction, the analyzing unit 25a of the printing unit 24a analyzes the document data 19a on the basis of the revision version number information “@03” (step S3; analysis step). That is, the analyzing unit 25a analyzes the document data 19a, thereby converting the document data 19a into character letter information printable by the print out unit 26.

Here, when the control character [symbol] is analyzed, the analyzing unit 25a recognizes the revision version number “03” on the basis of the control character [symbol] , thereby recognizing the revision version number information “ [symbol] 03” specified by the version number specifying unit 13.

Further, on the basis of the thus-recognized revision version number information “ [symbol] 03”, the analyzing unit 25a obtains special property information (here, broken underline) contained in the revision version number information “ [symbol] 03”, thereby obtaining the special property information corresponding to the revision version information “ [symbol] 03”, and analyzes only the letters with this special property as letters with the special property. As a result, the parts changed in revision version 3 indicated by the revision version number information “@03” are printed with letters to which the special property (broken underline) is added.

In contrast, as to the letters with special properties other than those indicated by the special property information corresponding to the revision version number information “ [symbol] 03” (that is, special property information corresponding to the revision version number information “ [symbol] 02” and “ [symbol] 04”), the analyzing unit 25a does not analyze the part into as letters as indicated by the properties, and analyzes the part as the original letters to which no such special properties are added.

Then, the print out unit 26 prints the analysis result obtained by the analyzing unit 25a (step S4; print step), thereby making it possible to print the parts changed in revision corresponding to the revision version number information “ [symbol] 03” with a property (here, as letters underlined by a broken line) different from that of the other parts of the document.

In this instance, as shown in FIG. 5, the above-mentioned step S3 (analysis step) and step S4 (print step) function as the print step S5.

In this manner, according to the printer system 1a and the printing method of the first embodiment of the present invention, the version number specifying unit 13 of the processing apparatus 10a specifies the revision version number information “ [symbol] 02 through [symbol] 04” of the document data 19a (version number specifying step). The print instructing unit 14a issues a print instruction including the document data 19a and the revision version number information “@02 through @04” set by the version number specifying unit 13, and the printing unit 24a of the printer apparatus 20a performs, on the basis of the revision version information “@02 through @04” specified by the version number specifying unit 13, a print operation of the parts which have been changed in the specified version with a property different from that of the other parts of the document (print step). Thus, even in a case where the document data 19a has been revised a multiple number of times, when the document data 19a is printed, the version number specifying unit 13 specifies a specific one of the revision version information pieces of “@02”, “@03”, and “@04”, thereby printing the document with emphasis only on the changed part with a property different from that of the other parts of the document. As a result, the printed document becomes easy to see, and it becomes possible for an operator to easily recognize parts changed at the time of a specific revision in printed documents.

At this time, the printing unit 24a performs a printing operation on the basis of the special property information corresponding to the revision version number information “@02 through @04” set by the version number specifying unit 13. It is thus possible for the printing unit 24a to print parts which have been changed at a revision specified by the version number specifying unit 13, with emphasis so that the changed parts are distinguishable from other parts.

Further, since the printing unit 24a has the analyzing unit 25a, which analyzes the document data 19a based on the revision version number information “@02 through @04”, and the print out unit 26, which prints the analysis result obtained by the analyzing unit 25a, it is possible to print parts revised at revision corresponding to the revision version number information “@02 through @04” with a property different from that of the other parts of the document.

Still further, the revision number information “@02 through @04” contains revision version numbers “02 through 04”, which are contained in the document data as character letter information. Since the analyzing unit 25a performs analysis based on the revision version numbers “02 through 04” which is recorded (written in) in the document data 19a, it is possible to reliably print the parts revised at the corresponding revision version with emphasis in the document data 19a, based on the revision version number information “@02 through @04” input as character letters by an operator.

Furthermore, the document data 19a contains the revision version numbers “02 through 04” as the revision version number information “@02 through @04” for each of the lines which include parts changed at the time of revision, and the analyzing unit 25a performs analysis based on the revision version number recorded in the document data 19a for each line. In addition to the above-described effects, it is possible to set revision (revision version number information “@02 through @04) for each line in detail. In this case, it is possible to reliably print the parts having been revised at the time of desired revision with emphasis.

Moreover, partly since the document data 19a contains the control character “@” as the revision version number information “@02 through @04”, and partly since the analyzing unit 25a recognizes the revision version numbers “02 through 04”, as the revision version number information “@02 through @04”, from the character letters of the document data 19a on the basis of the control character “@”, it is possible for the analyzing unit 25a to reliably recognize the revision version number information “@02 through @04”.

### [2] Second Embodiment

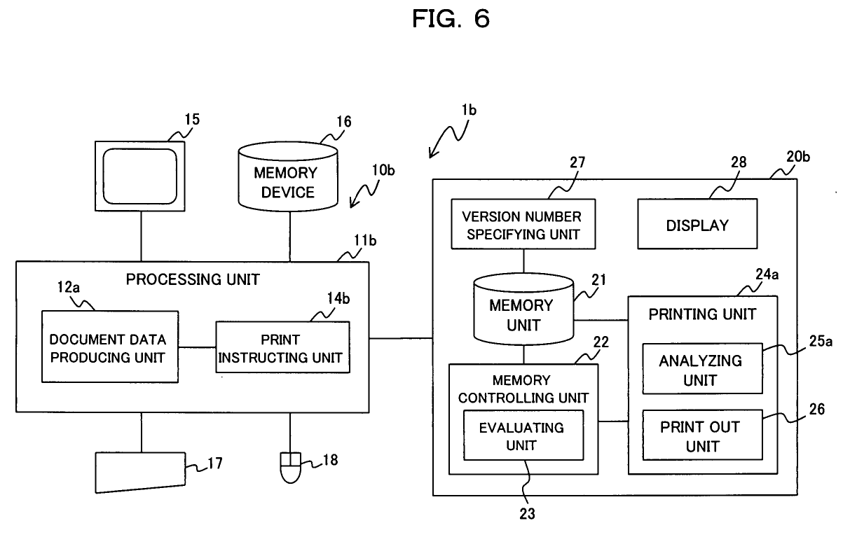

Next, referring to FIG. 6, a description will now be made of a printer system 1b according to a second embodiment of the present invention. As shown in FIG. 6, in the printer system 1b, the version number specifying unit 27 for specifying revision version number information of the document data 19a, is provided for the printer apparatus 20b, not for the processing apparatus 10a as in the case of the printer system 1a of the first embodiment. The remaining construction of the printer system 1b is approximately the same as that of the printer system 1a of the first embodiment.

Hence, a detailed description will be made hereinafter of the difference from the printer system la of the first embodiment. In this instance, in FIG. 6, like reference characters describe parts the same as or similar to those that have already been described, and thus a detailed description of such parts is omitted here.

As shown in FIG. 6, the processing unit 11b of the processing apparatus 10b in the present printer system 1b includes the document data producing unit 12a and a print instructing unit 14b.

The document data producing unit 12a is the same as that of the first embodiment, and produces document data 19a as shown in FIG. 2.

The print instructing unit 14b requests the printer apparatus 20b to print the document data 19a. Here, the print instructing unit 14b sends only the document data 19a as a print request to the printer apparatus 20b.

The printer apparatus 20b of the printer system 1b includes the version number specifying unit 27 and the display 28 in addition to the memory unit 21, the memory controlling unit 22, and the printing unit 24a.

When the printer apparatus 20b receives a print instruction from the print instructing unit 14b of the processing unit 11b of the processing apparatus 10b, the version number specifying unit 27, as in the case of the version number specifying unit 13 of the processing apparatus 10a of the printer system 1a already described, specifies the revision version number information “@02 through @04” in the document data 19a, to print the document data 19a, which have been created by the document data producing unit 12a of the processing apparatus 10b, with emphasis only on parts which have been changed at a specific revision performed.

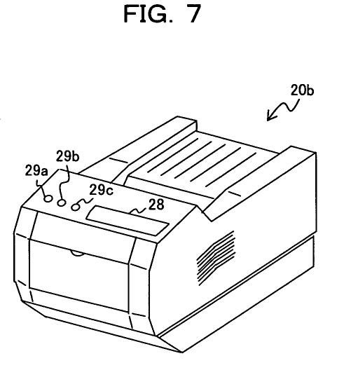

Here, FIG. 7 is a perspective view of the printer apparatus 20b. As shown in FIG. 7, the printer apparatus 20b has the display unit 28, the menu shift switch 29a, the selection switch 29b, and the setting switch 29c.

In the printer apparatus 20b, while cooperating with a display control unit (not illustrated), which controls the contents shown on the screen of the display 28, to show version number setting screen images 40a through 40h (will be detailed later) on the screen of the display 28, the version number specifying unit 27 specifies revision version number information on the basis of instructions input by an operator through the switches 29a through 29c.

More specifically, when a print request is received from the print instructing unit 14b of the processing apparatus 10b, the display 28 shows a print setting screen image. An operator operates the menu shift switch 29a (for example, pressing down the menu shift switch 29a a specified number of times), whereby a print setting screen image 40a on which a message “Specify Version No.” is shown appears on the screen of the display 28.

Here, the operator presses down the setting switch 29c, whereby a version number specifying screen image 40b is shown on the screen of the display 28. Then, the operator presses down a selection switch 29b, whereby a version specifying screen image 40c on which a message “set” is shown appears on the screen of the display 28. Under this state, if the setting switch 29c is pressed down, a message “*set” as shown in a version specifying screen image 40d appears on the screen of the display 28. At this stage, the practice of performing revision version number information specification is determined.

Next, a print setting screen image 40e on which a massage “Specify version No. to be printed” is shown appears on the screen of the display 28. If the operator presses down the setting switch 29c, a print version number specifying screen image (control character selecting screen image) 40f is shown on the screen of the display 28.

Then, the operator presses down the selection switch 29b a specified number of times to select the control character “@”. While the character “@” is being selected in the screen image, the setting switch 29c is pressed down, whereby a print version number specifying screen image (revision version number selecting screen image) 40g is shown on the display 28. Here, the operator presses down the selection switch 29b a specified number of times, whereby a print version number specifying screen image 40h in which the revision version number “03” is selected appears on the screen of the display 28. While “03” is being selected in the screen image, the setting switch 29c is pressed down by the operator, whereby the version number specifying unit 27 sets the revision version number information “@03”.

Further, in the printer apparatus 20b, when the version number specifying unit 27 sets revision version number information “@03” as already described, the thus-set revision version number information “@03” is recorded in the memory unit 21 by the memory controlling unit 22.

In addition, the analyzing unit 25a of the printing unit 24a performs analysis based on the document data 19a contained in the print request recorded by the memory unit 21 and the revision version number information “@03” set by the version number specifying unit 27. The print out unit 26 then prints the analysis result, thereby printing the document 19b as shown in FIG. 4.

As described so far, according to the printer system 1b of the second embodiment of the present invention, similar effects and benefits to those of the first embodiment already described are obtained. In addition, since the printer apparatus 20b includes the version number specifying unit 27 which sets revision version number information, the present printer system 1b is easily realized by connecting the printer apparatus 20b to the previous processing apparatus 10b having no such function (that is, the version number specifying unit 13 of the first embodiment), without adding a function for setting the revision version number information to the processing apparatus 10b.

### [3] Other Modifications

The present invention should by no means be limited to the above-illustrated embodiment, and various changes or modifications may be suggested without departing from the gist of the invention.

For example, according to the above embodiments, the special property corresponding to revision version number information of the document data 19a produced by the document data producing unit 12a of the processing unit 11a, 11b of the processing apparatus 10a, 10b is varying types of underlines. The present invention should by no means be limited to this. As a special property (special property information) of letters which are changed when revision is performed, the following are usable: the color, the font, the size, and the thickness of letters; the presence or absence of an underline; the type of underline; the presence or absence of shading; the type of shading; the presence or absence of a strike-through; the type of a strike-through.

In this instance, when the color of letters which are changed at the time of revision is altered into a color different from that of the other parts of the document (that is, letter color is set as special property information), color printing becomes a precondition for the printing unit 24a to print the parts changed at revision with a property different from the other parts of the document.

Further, in the previous embodiments, each of the version number specifying units 13 and 27 specifies one piece of revision version number information. The present invention should by no means be limited to this. In this case, the printing unit 24a of the printer apparatuses 20a and 20b prints, on the basis of the multiple pieces of revision version number information, parts changed at multiple revisions corresponding to the multiple pieces of revision version number information, with properties different from that of the other parts of the document.

Further, in the above embodiment, the revision version number information contained in the document data 19a produced by the document data producing unit 12a of the processing units 11a and 11b of the processing apparatuses 10a and 10b, respectively, is directly input (typed in) by an operator. In addition, underlines and strike-throughs added to letters changed at the time of revision are directly input (typed in) by an operator. The present invention should by no means be limited to this. For example, the revision version number information and the special property information can be automatically produced by means of a document data producing tool.

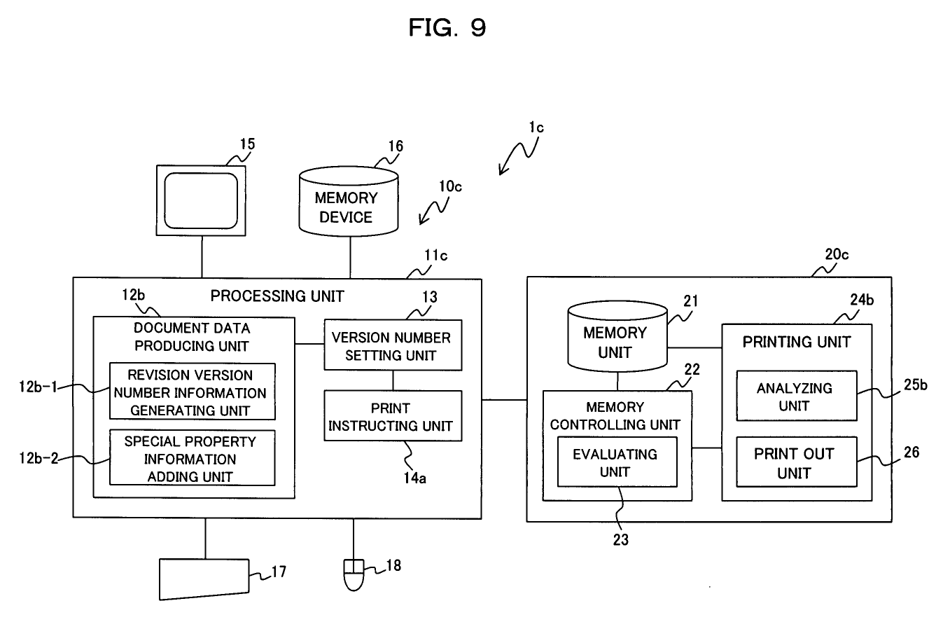

For example, as shown in FIG. 9, in the printer system 1c as a modified example of the present invention, the document data producing unit 12b of the processing unit 11c of the processing apparatus 10c can include: revision version number information producing unit 12b-1, which automatically produces revision version number information in association with the parts changed when the document data is changed and the version number is changed; and a special property information adding unit 12b-2, which alters the changed parts into letters with a property different from that of the other parts of the document.

In this case, the revision version number information produced by the revision version number information producing unit 12b-1 need not be displayed as a character letter in the document data. The revision version number information is contained in the document data in association with the parts changed at the time of revision.

Further, the special property information adding unit 12b-2 automatically changes the property of the changed parts to be different from the property of the other parts of the document, based on an operator's instructions input through the key board 17 and the mouse 18, thereby producing and adding special property information.

Further, when an operator deletes some of the letters by operating a “backspace key” or “delete key” of the keyboard 17, the special property information adding unit 12b-2 automatically adds strike-throughs to the deleted letters and the letters are displayed as change tracking.

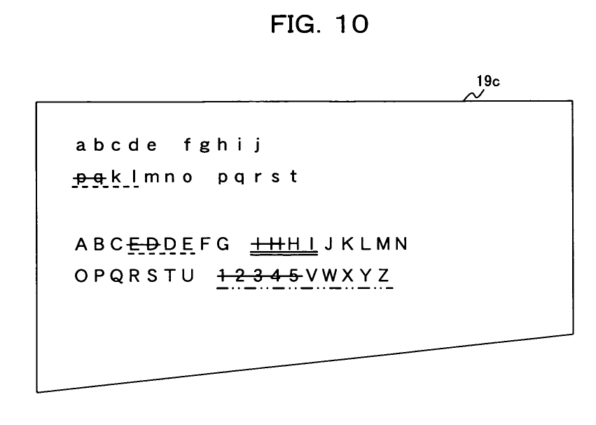

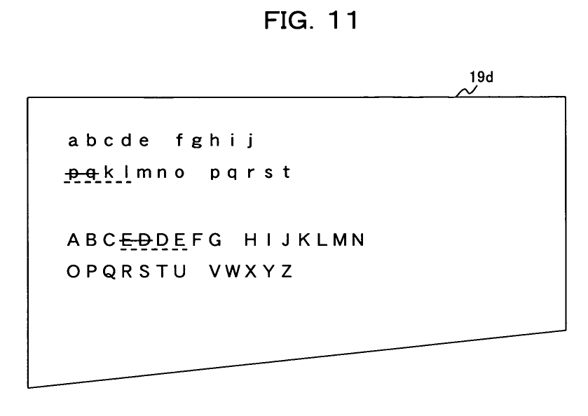

Hence, according to the printer system 1c of the present modified example, in a case where the document data 19c is automatically produced as shown in FIG. 10, when the printing unit 24b of the printer apparatus 20c prints out document data based on the revision version number information (for example, “@03” of the revision version number information at the time of revision corresponding to the broken underline) specified by the version number specifying unit 13, the document 19d as shown in FIG. 11 is printed.

That is, letters “p”, “q”, “E”, and “D” deleted at the time of revision corresponding to the revision version number information “@03” set by the version number specifying unit 13 are printed together with strike-throughs added thereon, and these deleted letters and newly added letters “k”, “l”, “D”, and “E”, are printed with a broken underline added thereto.

On the other hand, the parts changed at other revisions (here, the parts underlined with a two-dotted line and a double line) are printed with original letters which are not underlined.

Further, letters deleted at the time of other revisions (here, “1” through “5”, “I”, and “H”, on which strike-throughs are put in the document data 19c) are not printed, and such deletion at the time of other revisions is reflected in what is printed.

In this instance, when a print request occurs, the analysis unit 25b of the printing unit 24b of the printer apparatus 20c of the printer system 1c need not recognize revision version number information by analyzing letters of the document data 19c, as in the already described embodiments. The analysis unit 25b simply extracts revision version number information as data contained in the document data 19c recorded in the memory unit 21. On the basis of the extracted revision version number information, the analysis unit 25b recognizes parts changed at the time of the revision in the document data 19c, and analyzes the document data 19c so that only the changed parts are printed with the property indicated by the special property information.

In this manner, the printer system 1c of the present modified example realizes similar effects and benefits to those of the above-described embodiments. Further, on the basis of revision version number information or special property information which is automatically produced by the revision version number information producing unit 12b-1 and the special property information adding unit 12b-2, the printer system 1c performs the above-mentioned print processing. The operator is capable of easily printing a document in which only the parts changed at the time of specified revision is typed with a property different from that of the other parts of the document, without inputting revision version number information or special property information through the keyboard 17 and the mouse 18.

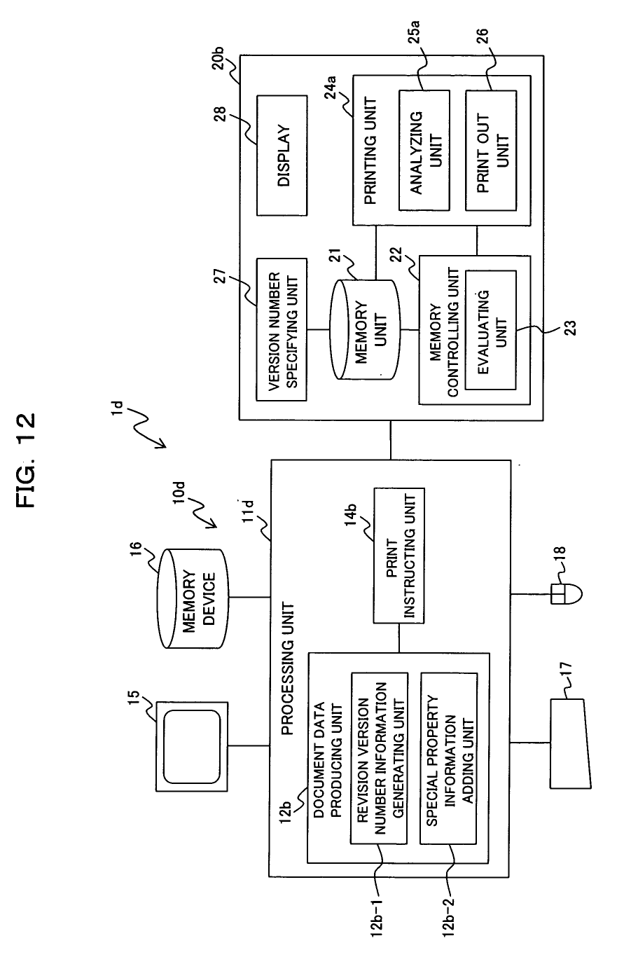

In addition, as a further modified example of the modified example of the printer system 1c, as shown in FIG. 12, changes similar to those in the printer system 1b of the second embodiment, which changes added to the printer system 1a of the first embodiment, are added to the printer system 1c, whereby a printer system 1d is constructed.

In this instance, in FIG. 12, like reference characters to those that have been already described designate the same or approximately the same parts.

According to the printer system 1d as this modified example, like effects and benefits to those of the printer system 1c, and also, like effects to those of the printer system 1b of the second embodiment are realized.

In this instance, the functions as the above-described document data producing units 12a and 12b, the revision version number information producing unit 12b-1, the special property information adding unit 12b-2, the version number specifying units 13 and 27, the print instructing units 14a and 14b, the memory controlling unit 22, the evaluating unit 23, the printing units 24a and 24b, and the analyzing units 25a and 25b can be realized by a computer (CPU, information processing apparatus, varying types of terminals) which executes a specified application program (print control program).

The program is recorded in computer-readable recordingmedia such as flexible discs, CDs (CD-ROMs, CD-Rs, and CD-RWs), and DVDs (DVD-ROMs, DVD-RAMs, DVD-Rs, DVD-RWs, DVD+Rs, and DVD+RWS). The computer reads the programs from such recording media to transfer the programs to an internal or external storage device, to store the programs therein. Alternatively, the programs can be recorded in storage devices (recording media) such as magnetic discs, optical discs, and magneto-optical discs, to be transferred to the computer over a communication network.

Here, the “computer” is defined as a concept including hardware and an OS (Operating System), or hardware operating under control of an OS. Further, in cases where hardware is capable of operating by itself without the necessity of an OS, the hardware is equivalent to the “computer.” The hardware includes at least a micro processor such as a CPU and a means for reading computer programs from recording media.

The aforementioned predetermined application program contains program codes that instruct the computer to function as the document data producing units 12a and 12b, the revision version number information producing unit 12b-1, the special property information adding unit 12b-2, the version number specifying units 13 and 27, the print instructing units 14a and 14b, the memory controlling unit 22, the evaluating unit 23, the printing unit 24a and 24b, and the analyzing units 25a and 25b. Further, a part of those functions can be realized by the OS, not by such application programs.

Moreover, as recording media used in the embodiments of the present invention, not only the above-mentioned flexible discs, CDs, DVDs, magnetic discs, optical discs, and magneto-optical discs, but also varying types of other computer-readable media, such as IC cards, ROM cartridges, magnetic tapes, punch cards, internal storage devices (memories such as RAMs and ROMs) of computers, external storage devices, and printed matter with any codes such as barcodes printed thereon, are also applicable.

What is claimed is:

1. A printer apparatus which prints document data including revision version number information that is generated when a document is revised by changing the contents thereof, said printer apparatus comprising:
a version number specifying unit which specifies the revision version number information of the document data; and
a printing unit which performs, on the basis of the revision version number information specified by said version number specifying unit, a printing operation of a revised part of the document corresponding to the revision version number information with a property different from that of the other parts of the document.

2. A printer apparatus as set forth in claim 1,
wherein the document data further includes special property information corresponding to the revision version number information, which special property information is obtained by changing the property of a part revised at the time of revision, and
wherein said printing unit performs the printing operation on the basis of the special property information corresponding to the revision version number information specified by said version number specifying unit.

3. A printer apparatus as set forth in claim 1, wherein said printing unit includes:
an analyzing unit which analyzes, in order to print the document data, character letters contained in the document data on the basis of the revision version number information specified by said version number specifying unit; and
a print-out unit which prints out an analysis result obtained by said analyzing unit.

4. A printer apparatus as set forth in claim 3,
wherein the revision number information contains at least a revision version number, the revision version number being contained in the document data as character letter information, and
wherein said analyzing unit of said printing unit performs the analysis on the basis of the revision version number recorded in the document data.

5. A printer apparatus as set forth in claim 4,
wherein the document data contains the revision version number as the revision version number information for each of the lines which include parts changed at the time of revision, and
wherein said analyzing unit of said printing unit performs the analysis on the basis of the revision version number recorded for each of the lines which include parts of the document data having been changed.

6. A printer apparatus as set forth in claim 4,
wherein the document data contains a control character letter recorded therein as the revision version number information, and
wherein said analyzing unit of said printing unit recognizes the revision version number on the basis of the control character letter.

7. A printer apparatus as set forth in claim 5,
wherein the document data contains a control character letter recorded therein as the revision version number information, and
wherein said analyzing unit of said printing unit recognizes the revision version number on the basis of the control character letter.

8. A printing method for printing document data including revision version number information that is generated when a document is revised by changing the contents thereof, said method comprising the steps of:
(a) specifying the revision version number information of the document data; and
(b) performing, on the basis of the revision version number information specified by said version number specifying unit, a printing operation of a revised part of the document corresponding to the revision version number information with a property different from that of the other parts of the document.

9. A printing method as set forth in claim 8,
wherein the document data further includes special property information corresponding to the revision version number information, which special property information is obtained by changing the property of a part revised at the time of revision, and
wherein the printing operation is performed on the step (b) on the basis of the special property information corresponding to the revision version number information specified on the step (a).

10. A printing method as set forth in claim 8, wherein said step (b) includes the steps of:
(b-1) analyzing, in order to print the document data, character letters contained in the document data on the basis of the revision version number information specified by said step (a); and
(b-2) printing out an analysis result obtained by the step (b-1).

11. A printing method as set forth in claim 10,
wherein the document data contains at least revision version number recorded therein as the revision version number information, and
wherein the analysis is performed on the basis of the revision version number recorded in the document data on said step (b-1) of said step (b).

12. A printing method as set forth in claim 11,
wherein the document data contains the revision version number as the revision version number information for each of the lines which include parts changed at the time of revision, and
wherein the analysis is performed, on the step (b-1) of the step (b), on the basis of the revision version number recorded for each of the lines which include parts of the document data having been changed.

13. A printing method as set forth in claim 11,
wherein the document data contains a control character letter recorded therein as the revision version number information, and
wherein the revision version number is recognized on the basis of the control character letter on the step (b-1) of the step (b).

14. A printing method as set forth in claim 12,
wherein the document data contains a control character letter recorded therein as the revision version number information, and
wherein the revision version number is recognized on the basis of the control character letter on the step (b-1) of the step (b).

15. A printer system, comprising:
a processing apparatus which requests printing of document data which includes revision version number information that is generated when a document is revised by changing the contents thereof; and
a printer apparatus which prints the document data in response to a request from the processing apparatus,
said processing apparatus including a version number specifying unit which specifies the revision version number information of the document data;
said printing apparatus including a printing unit which performs, on the basis of the revision version number information specified by said version number specifying unit, a printing operation of a revised part of the document corresponding to the revision version number information with a property different from that of the other parts of the document.

16. A printer system as set forth in claim 15,
wherein the document data further includes special property information corresponding to the revision version number information, which special property information is obtained by changing the property of a part revised at the time of revision, and
wherein said printing unit of said printer apparatus performs the printing operation on the basis of the special property information corresponding to the revision version number information specified by said version number specifying unit.

17. A printer system as set forth in claim 15, wherein said printing unit of said printer apparatus includes:
an analyzing unit which analyzes, in order to print the document data, character letters contained in the document data on the basis of the revision version number information specified by said version number specifying unit; and
a print-out unit which prints out an analysis result obtained by said analyzing unit.

18. A printer system as set forth in claim 17,
wherein the document data contains at least revision version number recorded therein as the revision version number information, and
wherein said analyzing unit of said printing unit of said printer apparatus performs the analysis on the basis of the revision version number recorded in the document data.

19. A printer system as set forth in claim 18,
wherein the document data contains the revision version number as the revision version number information for each of the lines which include parts changed at the time of revision, and
wherein said analyzing unit of said printing unit of said printer apparatus performs the analysis on the basis of the revision version number recorded for each of the lines which include parts of the document data having been changed.

20. A printer system as set forth in claim 18,
wherein the document data contains a control character letter recorded therein as the revision version number information, and
wherein said analyzing unit of said printing unit of said printer apparatus recognizes the revision version number on the basis of the control character letter.
